(19) United States
(12) Patent Application Publication
(10) Pub. No.: US 2025/0267731 A1
(43) Pub. Date: Aug. 21, 2025

(54) RANDOM ACCESS FOR AMBIENT IOT

(71) Applicants: Yi Guo, Shanghai (CN); Sudeep K. Palat, Cheltenham (GB); Gang Xiong, Beaverton, OR (US); Marta Martinez Tarradell, Munchen (DE); Meng Zhang, Beijing (CN); Ziyi Li, Beijing (CN)

(72) Inventors: Yi Guo, Shanghai (CN); Sudeep K. Palat, Cheltenham (GB); Gang Xiong, Beaverton, OR (US); Marta Martinez Tarradell, Munchen (DE); Meng Zhang, Beijing (CN); Ziyi Li, Beijing (CN)

(21) Appl. No.: 19/199,706

(22) Filed: May 6, 2025

Related U.S. Application Data
(60) Provisional application No. 63/644,964, filed on May 9, 2024.

(51) Int. Cl. H04W 74/0833; H04W 48/10; H04W 74/00

(52) U.S. Cl. CPC H04W 74/085; H04W 48/10; H04W 74/006

(57) ABSTRACT

Systems and methods are disclosed for random access by Ambient Internet of Things (A-IoT) devices. A reader device transmits a trigger message containing control information and selection criteria to A-IoT devices. Devices meeting the criteria determine whether to initiate random access based on conditions in the trigger message, including an indication bit and/or a session number. Devices perform random backoff according to parameters in the trigger message before transmitting a contention resolution ID to the reader. The reader acknowledges receipt by responding using the same ID. For multiple device access, the reader transmits repeated trigger messages with the same session number, while devices that have already responded do not respond to messages with that session number. Timing parameters control when devices can transmit, and failure handling mechanisms allow devices to skip procedures and wait for the next round of operation when encountering errors.

### PRIORITY CLAIM

This application claims the benefit of priority to U.S. Provisional Patent Application Ser. No. 63/644,964, filed May 9, 2024, which is incorporated herein by reference in its entirety.

### TECHNICAL FIELD

Embodiments pertain to wireless networks and wireless communications. Some embodiments relate to random access channel (RACH) procedures for Ambient Internet of Things (A-IoT) devices.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various user equipment (UEs) and applications. NR is to be a unified network/system that is to meet vastly different and sometimes conflicting performance dimensions and services driven by different services and applications. As such, the complexity of such communication systems, as well as interactions between elements within a communication system, has increased. In particular, a number of applications demand devices with extremely limited size and power consumption that are unable to be met by current devices using protocols and mechanisms that can accommodate such constraints while maintaining reliable connectivity for massive numbers of devices operating in confined spaces.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 is a 4 step random access procedure, according to some examples.

FIG. 4 is a radio frequency identifier (RFID) random access procedure, according to some examples.

FIG. 5 is an A-IoT RACH procedure, according to some examples.

FIGS. 6A-6D are minimum times for transmissions, according to some examples.

FIG. 7 is an A-IoT inventory procedure with RACH, according to some examples.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

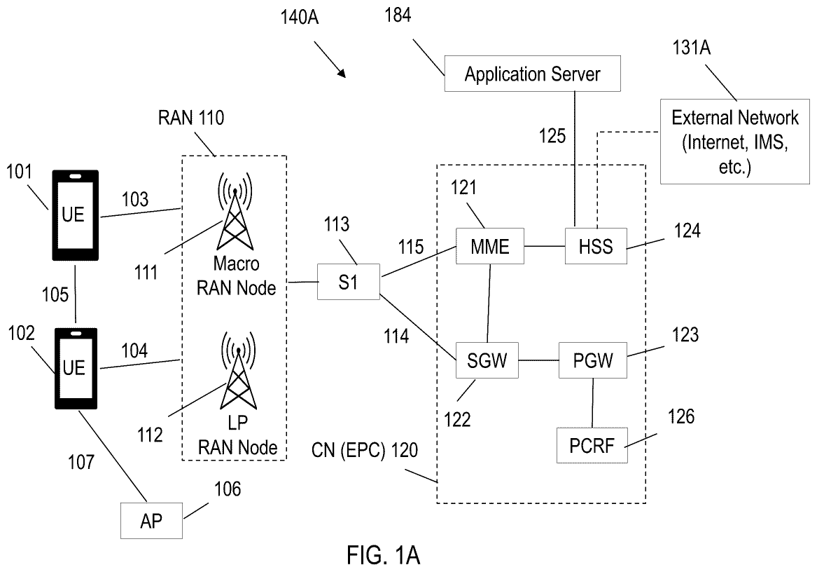

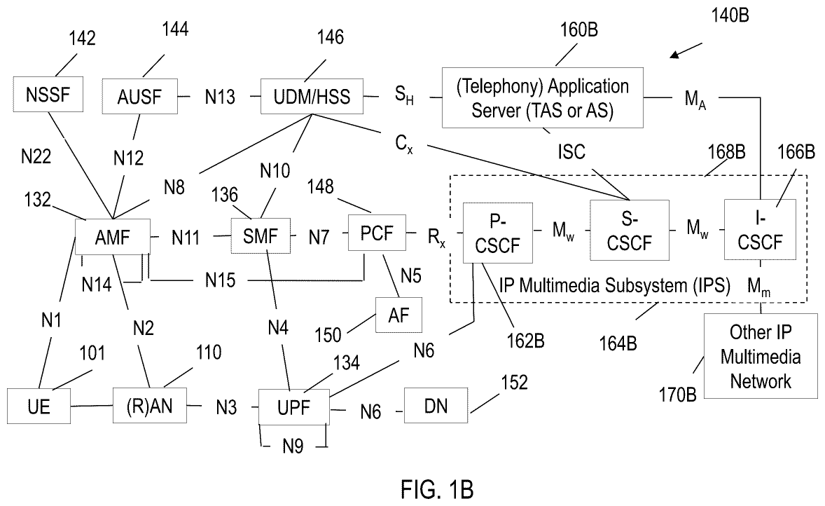

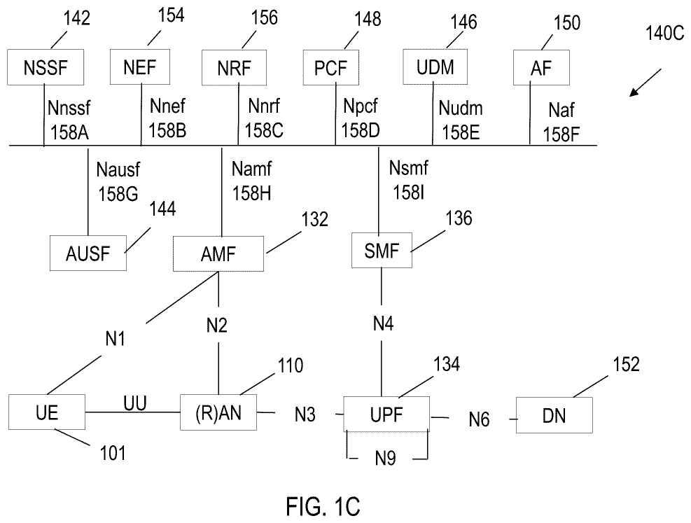

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

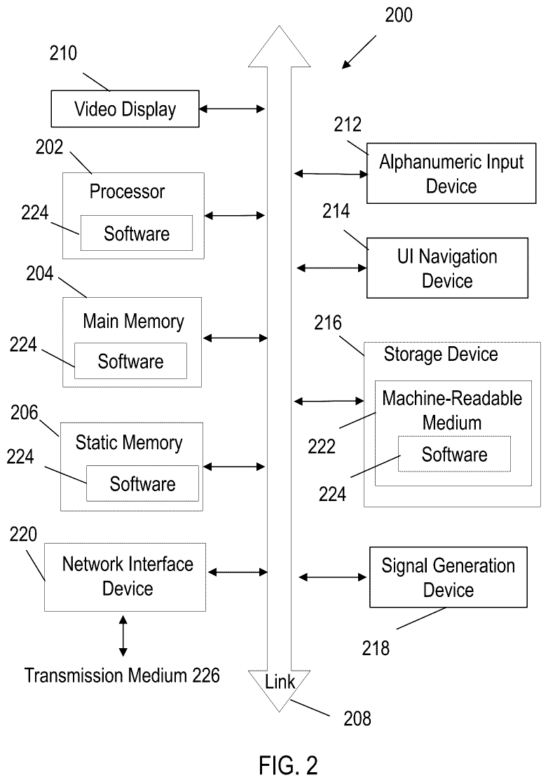

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V21) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, IoT has evolved to encompass diverse applications including smart home applications, smart city applications, and healthcare monitoring applications. In 3GPP, various connectivity technologies have been tailored to IoT applications, particularly Low Power, Wide-Area (LPWA) Technologies such as Narrowband IoT (NB-IoT) and LTE-M, which were specified to address the needs of low-power devices, extending battery life and enabling use in remote locations.

An IoT device is distinct from other 5G-enabled devices primarily in its purpose, design, and operational requirements. IoT devices are designed to collect, transmit, and act on data, often with minimal human intervention. They are embedded with sensors, software, and connectivity to interact with other devices or systems, enabling automation and data-driven decision-making. Examples include smart home devices, industrial sensors, and wearable health monitors. In contrast, other 5G devices, like smartphones or tablets, are primarily focused on user interaction, high-speed data consumption, and multimedia applications. IoT devices typically operate with low power consumption and minimal bandwidth, as they often transmit small amounts of data intermittently. Technologies like LTE-M and NB-IoT are tailored for these, offering energy efficiency and wide-area coverage. Other 5G devices, such as those used for enhanced mobile broadband (eMBB), require high bandwidth and continuous connectivity to support applications like HD video streaming and virtual reality. IoT devices are often deployed in massive numbers, sometimes reaching millions per square kilometer, to monitor and control environments or processes. This scalability is supported by 5G's Massive Machine-Type Communications (mMTC) capabilities. Other 5G devices, like smartphones, are used individually or in smaller clusters, focusing on personal or enterprise-level connectivity. While some IoT applications, such as industrial automation or autonomous vehicles, use ultra-reliable low-latency communication (URLLC), many IoT devices operate with less stringent latency requirements. In contrast, other 5G devices, particularly those used for real-time applications like gaming or video conferencing, demand consistently low latency and high reliability. IoT devices often integrate with various networks, including satellite, WiFi, and fixed lines, to create a seamless ecosystem. This enables IoT devices to adapt to different environments and use cases. Other 5G devices primarily rely on cellular networks for connectivity. Thus, IoT devices are specialized for data collection, automation, and scalability, often with low power and bandwidth needs, while other 5G devices focus on high-speed, user-centric applications with greater bandwidth and latency demands.

However, existing technologies are unable to meet all requirements for target use cases such as asset identification, inventory, and sensing. A-IoT technology may help to open new markets within 3GPP systems, with connection numbers and device density potentially orders of magnitude higher than existing 3GPP IoT technologies.

A-IoT devices are a subset of IoT devices that have more limited size with no energy storage capability or with limited energy storage that does not involve manual replacement or recharging. In some embodiments, the A-IoT device may be designed to not permit replacement or recharging of the energy source by an end user (without damaging the A-IoT device). The output power of energy harvesters for A-IoT devices may range from about 1 μW to a few hundred μW. Existing cellular devices may not work well with energy harvesting due to their peak power consumption exceeding 10 mW.

In more detail, IoT devices and A-IoT devices differ at least in power source and design. IoT devices typically rely on batteries or wired power sources for operation, are larger and involve periodic maintenance (such as battery replacement or recharging), and are designed to collect, process, and transmit data, often through direct human interaction or intervention for setup and management. A-IoT devices, on the other hand, harvest energy from ambient sources such as radio waves, light, motion, heat, or other environmental energy forms such as backscatter of a carrier wave signal transmitted by an emitter. This allows A-IoT devices to operate without batteries or with minimal reliance on such energy sources. A-IoT devices are also smaller, lower-cost, and maintenance-free, enabling greater scalability and flexibility in form factors. A-IoT devices can be deployed in environments where battery replacement or wired power is impractical. A-IoT devices are designed to operate autonomously in the background, with minimal or no human intervention.

For example, devices may use the harvested energy for signal generation and transmission. Backscattering devices may rely on an externally-provided carrier wave for signal transmission. These devices modulate data on an externally provided carrier wave and reflect the carrier wave toward a reader. From the readers perspective, backscattering ambient IoT devices can be in both monostatic and bistatic modes of operation. For monostatic operation, the reader serving a particular AIoT device provides the carrier wave to the AIoT device for signal transmission. For bistatic operation, the carrier wave source for AIoT signal transmission is a node that is different than the reader that serves a particular AIoT device.

A-IoT devices collect data from their surroundings, process the data, and respond autonomously to changing conditions in real-time, allowing such devices to be used in applications where automation and adaptability are employed such as asset tracking, smart metering, and environmental monitoring. A-IoT devices encompass a wide range of applications and can be found in various settings. Examples of applications in which A-IoT devices are used include smart thermostats, smart appliances, smart lighting systems, health and wellness applications, environmental sensors, security cameras, voice assistants, smart mirrors, automated blinds and shades, smart parking systems, smart agriculture sensors, and connected cars.

A-IoT devices operate in conjunction with a reader. The reader is a network entity that serves as an intermediary between the A-IoT devices and the core network. The reader may be, for example, a RAN node such as a gNB, eNB, distributed unit (DU), or transmission reception point (TRP).

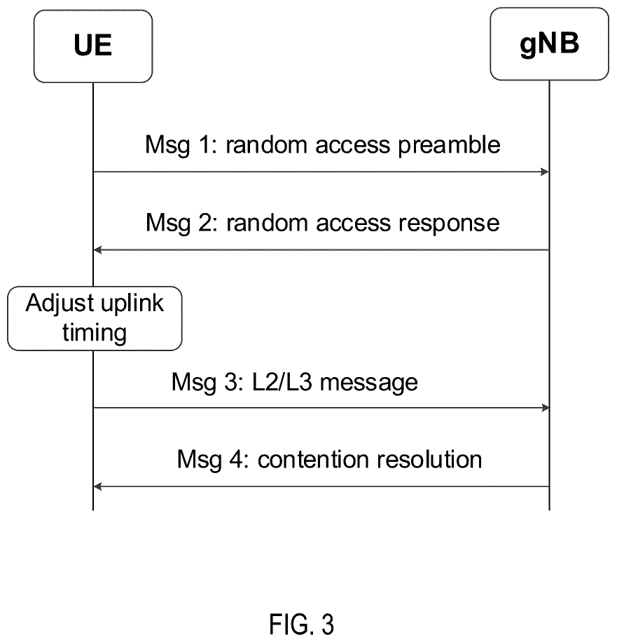

The RACH procedure enables UEs to establish communication with a gNB or other base station. A 4-step RACH procedure for initial access defined in NR Rel-15 is shown in FIG. 3. The UE transmits, as the first message (Msg 1) a physical random access channel (PRACH) in the uplink by randomly selecting a preamble signature. This permits the gNB to estimate the delay between the gNB and UE for subsequent uplink timing adjustment. The gNB provides a random access response (RAR) as Msg 2. The RAR carries a timing advanced (TA) command information and uplink grant for the uplink transmission. The UE adjusts the uplink timing based on the TA command and transmits a layer 2 (L2) and/or layer 3 (L3) message as Msg 3 using the grant received in the RAR. The gNB responds with a contention resolution message transmitted to the UE as Msg 4.

The UE expects to receive the RAR within a time window, of which the start and end are configured by the gNB via system information block (SIB). However, for A-IoT devices (which have extremely low power consumption), the existing random access procedure as defined in NR may not be able to be applied. For instance, A-IoT devices may only backscatter the carrier wave signal transmitted by emitter, where amplitude, frequency, and/or phase of the incoming signal may be changed for modulation. In addition, the communication range between the reader and A-IoT devices can be limited, which indicates that use of a PRACH-like signal may be avoided during the random access procedure. Thus, an alternate random access procedure may be used for A-IoT applications.

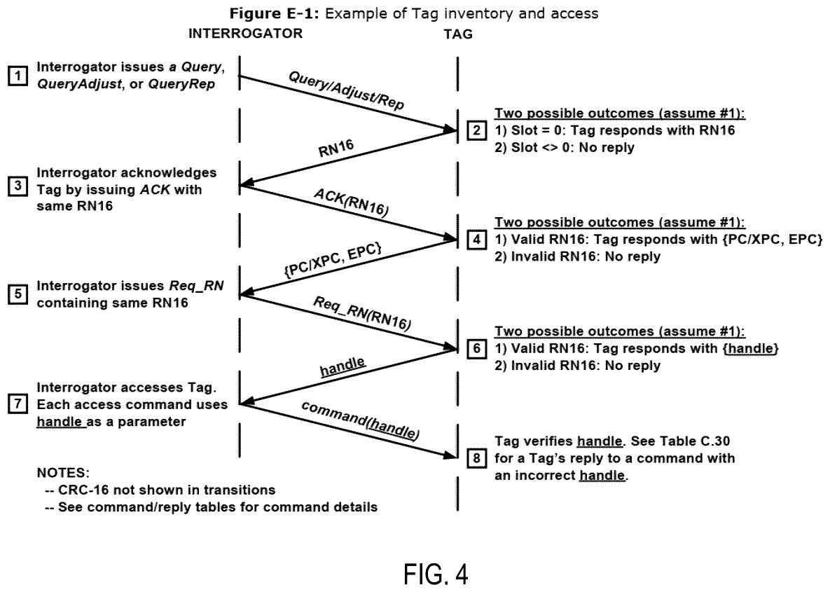

FIG. 4 is a RFID random access procedure, according to some examples. At operation 1 (Query Initiation), the Interrogator (Reader) issues a Query, QueryAdjust, or QueryRep message to the Tag (device). This message initiates the inventory process and contains parameters that determine how Tags should respond.

At operation 2 (Tag Response), after receiving the Query message, the Tag evaluates its slot value. If the slot value equals zero, the Tag responds with a 16-bit random number (RN16). If the slot value is not zero, the Tag does not reply. This mechanism helps manage contention when multiple Tags are present.

At operation 3 (Acknowledgment), the Interrogator acknowledges the Tag by issuing an ACK message containing the same RN16 value received from the Tag. This acknowledgment serves as a contention resolution mechanism.

At operation 4 (Tag Information Transmission), upon receiving the ACK with the correct RN16, the Tag responds with its PC/XPC (Protocol Control/Extended Protocol Control) and EPC (Electronic Product Code) information. If the RN16 value in the ACK is invalid, the Tag does not reply.

At operation 5 (Handle Request), the Interrogator issues a Req_RN message containing the same RN16 value to the Tag. This message requests a handle for subsequent access operations.

At operation 6 (Handle Response), if the RN16 value in the Req_RN message is valid, the Tag responds by providing a handle. If the RN16 value is invalid, the Tag does not reply.

At operation 7 (Tag Access), the Interrogator accesses the Tag using commands that include the handle as a parameter.

At operation 8 (Handle Verification), the Tag verifies the handle before processing each command.

This RFID random access procedure serves as a reference model for the A-IoT random access procedure, which adopts a similar approach but with modifications to accommodate the extremely low power consumption requirements of A-IoT devices.

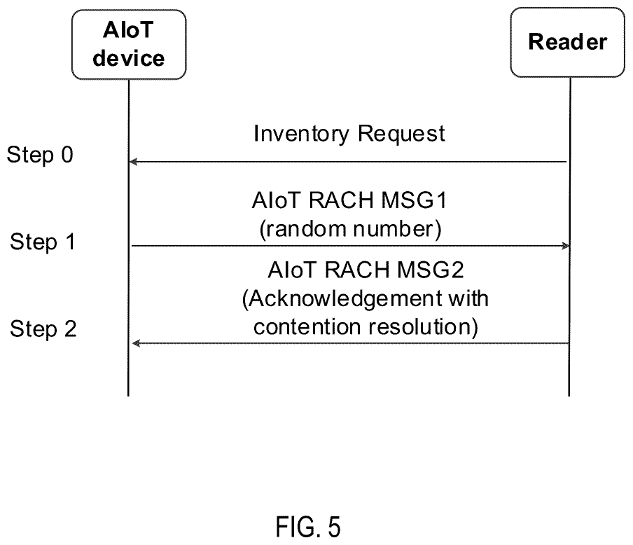

FIG. 5 is an A-IoT RACH procedure, according to some examples. As shown, at step 0, the reader may periodically send an Inventory request to a group of A-IoT devices. The Inventory request message may contain specific broadcast information, e.g., the backoff indication as defined for NR. Further, the reader may adjust the backoff indication in the following Inventory message, which may depend on the collision rate that is detected in the A-IoT system.

At step 1, according to the backoff indication, the group of A-IoT devices may randomly generate a backoff counter and perform random backoff for transmitting the first message to the reader. In this step, a contention resolution ID that is randomly generated from the A-IoT devices can be included in the first device-to-reader (D2R) message during the contention-based access procedure. When an A-IoT device receives the Inventory message, the A-IoT device may decrement the counter by 1 for random backoff. In addition, the contention resolution ID used in RFID is 16 bits, giving the probability of collision (simultaneously identical sequences) as: for a Tag population of up to 10,000 Tags, the probability that any two or more Tags simultaneously generate the same sequence of RN16s is less than 0.1%, regardless of when the Tags are energized. Considering the density requirements of “150 devices per 100 m² for indoor scenarios” and the coverage requirement is “the maximum distance of 10-50 m for indoor”, the maximum number of devices in the coverage for indoor scenario should be around 376 devices to 11,775 devices. Therefore, if a 16 bit RN is used, the worst collision probability is less than 0.1%, which is similar to RFID.

At step 2 (contention resolution), after correctly receiving the initial D2R message from the A-IoT device, the reader sends an acknowledgement message that may include the decoded contention resolution ID. If the contention resolution ID is same as the one sent by the A-IoT device in step 1, contention resolution is successful, and the A-IoT device is allowed to send the additional message with data. The A-IoT device sends a Device Response with device ID, data, etc. information back to the reader.

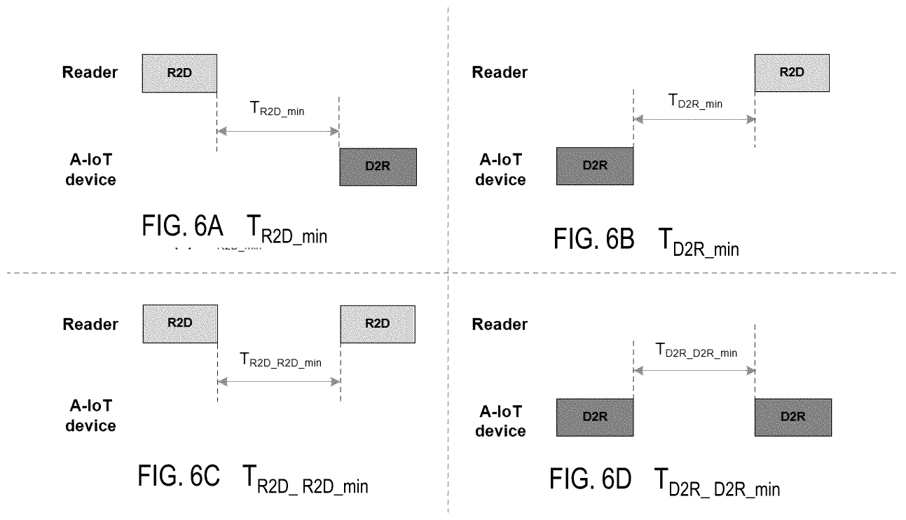

However, two issues remain to be considered: how to trigger the random access for other UEs if multiple UEs are to be addressed, and how to handle failure. To address these issues, the timing for the A-IoT device to send a D2R message is described. The minimum times are: T_{R2D_min}: the minimum time between a R2D transmission and the corresponding D2R transmission following the R2D transmission; T_{D2R_min}: the minimum time between a D2R transmission and the corresponding R2D transmission following the D2R transmission; T_{R2D_R2D_min}: the minimum time between two different consecutive R2D transmissions to the same A-IoT device; and T_{D2R_D2R_min}: the minimum time between two different consecutive D2R transmissions from the same A-IoT device. FIGS. 6A-6D are minimum times for the transmissions, according to some examples.

The timing of when an A-IoT device is able to transmit message to the reader is indicated by the above times. Thus, the transmission of a D2R message is triggered by a R2D message, and the A-IoT device responds based on T_{R2D_min}, and T_{R2D_max}. That is, an A-IoT device transmits a D2R message as the response to a R2D message in the period between two consecutive R2D messages within the minimum/maximum of R2D response timing. This timing constraint ensures that A-IoT devices with limited power resources can properly schedule transmissions to minimize energy consumption.

The A-IoT RACH procedure differs significantly from the traditional 4-step RACH procedure used in NR, as the A-IoT RACH procedure is optimized for devices with low power consumption that may rely on backscattering techniques rather than active transmission. This procedure is more similar to the RFID access procedure, which is better suited for the power constraints and communication characteristics of A-IoT devices.

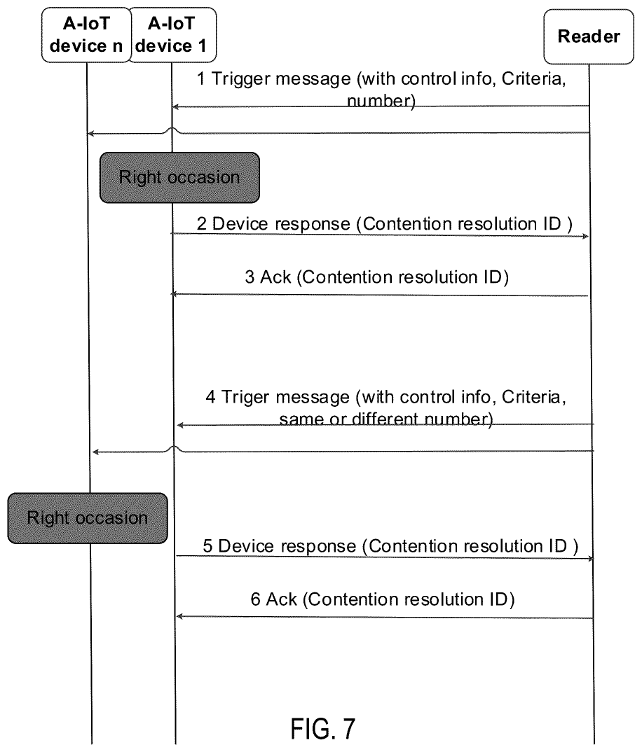

FIG. 7 is an A-IoT inventory procedure with RACH, according to some examples. In particular, FIG. 7 shows an inventory procedure for multiple devices (with random access procedure).

At step 1, the reader sends a broadcast trigger message (e.g., “InventoryRequest”) with selection criteria and control information (e.g., scheduling information, RACH related parameter) to request Device 1 to Device n under the coverage to trigger the random access procedure. Only devices meeting the criteria act.

Multiple conditions exist for an A-IoT device to determine whether random access is to be used. Condition 1: determine based on the indication in the trigger message, and Condition 2: determine based on the number and/or timer included in the trigger message.

The A-IoT device triggers the random access procedure at least one condition is met if multiple conditions are indicated in the message. The A-IoT device triggers the random access procedure if the condition that contained in the trigger message is met.

For condition 1, the reader may include an indication in the trigger message to indicate whether random access should be triggered. Various options may be used for condition 1. In a first option, the indication may be a bit (the value may be 0 or 1, or absent, present). For instance, 0 may mean random access is to be used, 1 may mean random access is not to be used or vice versa. Alternatively, the presence of the bit means random access is not to be used, or the presence of the indication means the random access is to be used.

In a second option, the indication can be reflected based on the message type, e.g., the use of an inventory message implies that random access is to be used, while a command message implies that random access is not to be used.

In a third option, the indication can be reflected based on the requested ID, e.g., a message to trigger the access of multiple devices means that the random access is to be used, while a message to trigger the access of a single device means random access is not to be used.

For condition 2, in a first embodiment, the determination is based on a number included in the trigger message. The reader also indicates whether or not the trigger message is for the same procedure/session. The determination can be achieved by including a number, e.g., Session ID, procedure ID, or a predetermined number (different numbers are used for different procedures, but the same number is used for the same procedure). If the number is different, the devices are to respond to the request even if a response to the request has been sent in another procedure/session for the same event. If the number is the same, the devices that have responded to the request ignore the request, i.e., the devices do not respond.

For condition 2, in a second embodiment, the determination is based on a timer included in the trigger message or a predefined timer. The number may wrap around, in which case the A-IoT device treats the number as a new trigger.

FIG. 7 illustrates how multiple A-IoT devices can sequentially access the network through a controlled random access procedure, with the reader managing the process through repeated trigger messages. This approach accommodates the energy constraints of A-IoT devices while efficiently handling potential contention among multiple devices attempting to simultaneously access the network.

Some A-IoT devices may receive a message with a number but miss the rest of messages before the wrap around, and therefore has no idea whether random access is to be used. One manner of mitigating this issue is to introduce a timer, thereby allowing the A-IoT device to (re)start the timer in response to receiving a trigger message, and treat the trigger message as a new procedure regardless of whether the number is same or not if the timer is expired.

Criteria is used to indicate which A-IoT device(s) should reply to the trigger message. The criteria may include one or more of device ID, device ID with mask or particular address and the corresponding data stored in A-IoT device's memory that can be detected by the A-IoT device. The criteria may indicate a particular device or a group of devices.

Returning to FIG. 7, at step 2, if A-IoT device 1 determines that A-IoT device 1 is to respond (based on backoff or counter in the trigger message, the (minimum) timing described above, and/or A-IoT device 1 has enough energy to complete the procedure, e.g., meeting a threshold (e.g., an absolute power level), 20% power, etc.), and if the device has not yet responded to the request for the procedure (detected based on the number contained in the trigger message), one or more actions may be undertaken. For example, A-IoT device 1 triggers random access if A-IoT device 1 has not triggered random access for the trigger message with the same number before the number wrap around. Number wrap around refers to the situation where a session or procedure number used in the trigger messages from the reader cycles back to an initial value after reaching a maximum value. In addition, A-IoT device 1 skips random access if A-IoT device 1 has triggered the random access for the trigger message with the same number before the number wrap around. Moreover, A-IoT device 1 triggers the random access even if A-IoT device 1 has triggered the random access for the trigger message with the same number if the number has wrapped around. A-IoT device 1 sends random access MSG1 (Device Response) with contention resolution ID to the reader.

At step 3, the reader sends an acknowledgment (ACK) with the contention resolution ID received from A-IoT device 1 to confirm the access of A-IoT device 1. If the contention resolution ID in the ACK is same as the contention resolution ID sent by A-IoT device 1 in step 2, A-IoT device 1 considers contention resolution successful.

At step 4, if the reader has not completed the procedure (e.g., has not reached the maximum times, periodicity, has not received the maximum number of feedback messages, etc.), the reader resends the broadcast trigger message with the same number as the number contained in the first Inventory Request message. To avoid the scenario that some A-IoT devices were out of coverage and did not receive the first trigger message for the procedure, the reader may provide selection criteria and control information (e.g., scheduling information, RACH related parameters) to request A-IoT devices under the area to trigger the random access procedure. The reader may determine maximum times, periodicity, or maximum number of feedback messages from the core network or an application when sending a message such as service request, inventory request, or command to the reader. The reader may also obtain this information by other means, such as based on pre-configuration from the Operations, Administration and Maintenance (OAM), core network or operator.

At step 5, if A-IoT device n determines that a response is to be undertaken (based on backoff or counter in the trigger message, the minimum timing described above, and/or has enough energy to complete the procedure (e.g., a threshold, 20% power, etc.), and if A-IoT device n has not yet responded to the request for the procedure (detected based on the number contained in the trigger message), A-IoT device n sends random access MSG1 (Device Response) with a contention resolution ID to the reader.

At step 6, the reader sends an acknowledgment (ACK) with the contention resolution ID received from A-IoT device n to confirm the access of A-IoT device n. If the contention resolution ID in the ACK is same as the contention resolution ID sent by A-IoT device n in step 5, A-IoT device n considers contention resolution successful.

In some cases, an A-IoT device may have an insufficient amount of power to complete an operation. In some cases, the network may guarantee that there is enough time for the A-IoT device to obtain power sufficient for the operation, and an A-IoT device always monitors R2D messages if the A-IoT device has enough energy to handle the operation. However, as A-IoT is an unsynchronized system, System Frame Numbers (SFNs) and timing may be problematic. The A-IoT device may, for example, only know the timing based on downlink messages. That is, an A-IoT device can transmit a D2R message in response to a R2D message in the period between two consecutive R2D messages within min/max of the R2D response timing. Therefore, if an error occurs due to insufficient power (the A-IoT device does not have enough energy to complete the procedure), a downlink message may be the trigger for the A-IOT device to know when to transmit an uplink message for the same session. In this case, the A-IoT device may skip the procedure and wait for the next round of operation.

In addition, different RACH-related failure cases may occur. For example, contention resolution failure may occur due to collision with other A-IoT devices. In this case, the random number received in the ACK is different from the random number transmitted by the A-IoT device. Another failure may be that a response from the reader is not received in the period between two consecutive R2D messages and/or within min/max of R2D response timing. The same handling can be applied for these RACH related failure cases-the A-IoT device may skip the procedure and wait for the next round of operation (the trigger message at step 4 of FIG. 7). In this case, the A-IoT device waits for the reader to trigger the next round of operation upon failure, e.g. RACH failure.

The embodiments herein relate to random access procedures for A-IoT devices. Unlike traditional cellular networks that use a 4-step random access procedure, A-IoT devices use a more energy-efficient approach similar to RFID systems. A slotted-ALOHA based random access procedure for A-IoT begins with a reader transmitting a trigger message to A-IoT devices within its coverage area. The trigger message contains control information, selection criteria, and random access parameters that determine which devices should respond and when the devices are to respond.

Upon receiving the trigger message, A-IoT devices that meet the specified criteria determine whether a random access is to be initiated based on conditions included in the trigger message. These conditions may include an explicit indication bit, a session or procedure number, or timing parameters. The A-IoT devices then perform a random backoff according to the backoff indication provided by the reader.

When an A-IoT device determines it is the appropriate time to respond, the A-IoT device transmits a message containing a contention resolution ID to the reader. This ID is typically a randomly generated number that helps identify the A-IoT device during the contention resolution process. The reader acknowledges receipt by sending back the same contention resolution ID, confirming successful access for the A-IoT device.

For multiple device access scenarios, the reader may transmit repeated trigger messages with the same session number to collect responses from different A-IoT devices. A-IoT devices that have already responded to a trigger message with a particular session number do not respond again to subsequent messages with the same number, allowing new A-IoT devices to gain access without interference from previously accessed A-IoT devices.

The timing for D2R transmissions follows specific timing parameters, including TR2D_min (minimum time between reader-to-device transmission and corresponding device-to-reader response), TD2R_min (minimum time between device-to-reader transmission and corresponding reader-to-device response), TR2D_R2D_min (minimum time between consecutive reader-to-device transmissions), and TD2R_D2R_min (minimum time between consecutive device-to-reader transmissions).

The examples also address failure handling scenarios. In cases in which an A-IoT device lacks sufficient energy to complete an operation, the A-IoT device skips the current procedure and waits for the next round of operation triggered by a new message from the reader. Similarly, for random access failures such as contention resolution failures or absence of reader response, the A-IoT device waits for the reader to trigger the next round of operation.

To prevent indefinite waiting in case of missed messages, a timer mechanism is implemented. When an A-IoT device receives a trigger message with a particular session number, the A-IoT device starts or restarts a timer. If the timer expires, the A-IoT device treats any subsequent trigger message as a new procedure regardless of whether the session number is the same or different.

The reader determines when to complete a procedure based on reaching maximum transmission times, transmission duration, or receiving the maximum number of expected responses. These parameters may be obtained from the core network, application layer, or OAM systems.

The random access procedure accommodates the severe energy constraints of A-IoT devices by minimizing the number of transmissions used and allowing A-IoT devices to participate only when the A-IoT devices have sufficient energy. The random access procedure also handles high device density through efficient contention resolution and prevents unnecessary retransmissions from A-IoT devices that have already successfully accessed the network.

Alternative implementations include variations in how A-IoT devices determine whether random access is to be used. Options include using a dedicated indication bit in the trigger message, inferring random access based on the message type (e.g., inventory message vs command message), or determining based on whether the message targets multiple devices or a single device.

Different approaches are considered for handling number wrap-around scenarios and timer-based mechanisms to ensure devices can properly identify new procedures even when message numbering is reused.

### EXAMPLES

Example 1 is an apparatus of an Ambient Internet of Things (A-IoT) device, the apparatus comprising a memory configured to store parameters for a random access procedure and a processor, the processor to configure the A-IoT device to: receive a trigger message from a reader, the trigger message indicating whether the A-IoT device is to perform the random access procedure; determine, based on the trigger message, whether a condition to trigger the random access procedure is met; determine whether to respond to the trigger message; and in response to a determination that the A-IoT device is to respond to the trigger message and that the condition to trigger random access is met, transmit a device-to-reader (D2R) message to the reader using the random access procedure.

In Example 2, the subject matter of Example 1 includes, wherein the trigger message includes the condition, and the condition comprises at least one of a session or procedure number, an indication bit to trigger the random access procedure, or timing parameters.

In Example 3, the subject matter of Example 2 includes, wherein the processor configures the A-IoT device to: trigger the random access procedure in response to not having triggered the random access procedure for a different trigger message with an identical session or procedure number before number wrap around, and skip the random access procedure in response to having triggered the random access procedure for the different trigger message with the identical session or procedure number before number wrap around.

In Example 4, the subject matter of Examples 2-3 includes, wherein the processor configures the A-IoT device to trigger the random access procedure even if the random access procedure has been triggered for a different trigger message with an identical session or procedure number after number wrap around.

In Example 5, the subject matter of Examples 2-4 includes, wherein the processor configures the A-IoT device to start a timer in response to triggering of the random access procedure or restart the timer in response to triggering a new random access procedure.

In Example 6, the subject matter of Example 5 includes, wherein the trigger message indicates that the random access procedure is to be triggered in response to the timer having expired.

In Example 7, the subject matter of Examples 2-6 includes, wherein: the processor configures the A-IoT device to determine allowed transmission timing based on messages transmitted by the reader, and the transmission timing is a period at least one of: between two consecutive reader-to-device (R2D) messages, or within a minimum response time and a maximum response time after reception of a first R2D message.

In Example 8, the subject matter of Examples 1-7 includes, wherein the condition is indicated in the trigger message.

In Example 9, the subject matter of Examples 1-8 includes, wherein the condition is a number of A-IoT devices for which the trigger message is intended.

In Example 10, the subject matter of Example 9 includes, wherein the processor configures the A-IoT device to: determine whether the trigger message is a broadcast message, and in response to a determination that the trigger message is the broadcast message, use the random access procedure to transmit the D2R message.

In Example 11, the subject matter of Examples 1-10 includes, wherein: the processor configures the A-IoT device to determine an amount of energy available, and the condition is dependent on whether the amount of energy available is sufficient to respond to the trigger message.

In Example 12, the subject matter of Examples 1-11 includes, wherein the processor configures the A-IoT device to: determine whether a random access-related failure has occurred, and respond to the trigger message in a next transmission timing in response to a determination that the condition has been met and the random access-related failure has occurred.

In Example 13, the subject matter of Example 12 includes, wherein the random access-related failure comprises at least one of a contention resolution failure or an absence of feedback from the reader.

In Example 14, the subject matter of Examples 1-13 includes, wherein: the D2R message comprises a contention resolution ID, and the processor configures the A-IoT device to: receive, from the reader, an acknowledgement message that contains a response contention resolution ID, determine whether the contention resolution ID and the response contention resolution ID are identical, and determine that contention resolution is successful in response to a determination that the contention resolution ID and the response contention resolution ID are identical.

In Example 15, the subject matter of Examples 1-14 includes, wherein the processor configures the A-IoT device to determine whether to use the random access procedure based on a value of an indication bit in the trigger message.

In Example 16, the subject matter of Examples 1-15 includes, wherein the processor configures the A-IoT device to determine whether to use the random access procedure based on absence of an indication bit in the trigger message.

Example 17 is an apparatus of a reader, the apparatus comprising a memory configured to store parameters for a random access procedure and a processor, the processor to configure the reader to: send, to an Ambient Internet of Things (A-IoT) device, a trigger message indicating whether the A-IoT device is to perform the random access procedure based on at least one of a session or procedure number, an indication bit, or timing parameters; and receive, from the A-IoT device in response to the trigger message, a device-to-reader (D2R) message using the random access procedure.

In Example 18, the subject matter of Example 17 includes, wherein the random access procedure is based on a value of the indication bit in the trigger message.

Example 19 is a non-transitory computer-readable storage medium that stores instructions for execution by one or more processors of an apparatus of an Ambient Internet of Things (A-IoT) device, the instructions, when executed, cause the A-IoT device to: receive a trigger message from a reader, the trigger message indicating whether the A-IoT device is to perform a random access procedure; determine, based on the trigger message, whether a condition to trigger the random access procedure is met; determine whether to respond to the trigger message; and in response to a determination that the A-IoT device is to respond to the trigger message and that the condition to trigger random access is met, transmit a device-to-reader (D2R) message to the reader using the random access procedure.

In Example 20, the subject matter of Example 19 includes, wherein the trigger message includes the condition, and the condition comprises at least one of a session or procedure number, an indication bit to trigger the random access procedure, or timing parameters.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of an Ambient Internet of Things (A-IoT) device, the apparatus comprising a memory configured to store parameters for a random access procedure and a processor, the processor to configure the A-IoT device to:
receive a trigger message from a reader, the trigger message indicating whether the A-IoT device is to perform the random access procedure;
determine, based on the trigger message, whether a condition to trigger the random access procedure is met;
determine whether to respond to the trigger message; and
in response to a determination that the A-IoT device is to respond to the trigger message and that the condition to trigger random access is met, transmit a device-to-reader (D2R) message to the reader using the random access procedure.

2. The apparatus of claim 1, wherein the trigger message includes the condition, and the condition comprises at least one of a session or procedure number, an indication bit to trigger the random access procedure, or timing parameters.

3. The apparatus of claim 2, wherein the processor configures the A-IoT device to:
trigger the random access procedure in response to not having triggered the random access procedure for a different trigger message with an identical session or procedure number before number wrap around, and
skip the random access procedure in response to having triggered the random access procedure for the different trigger message with the identical session or procedure number before number wrap around.

4. The apparatus of claim 2, wherein the processor configures the A-IoT device to trigger the random access procedure even if the random access procedure has been triggered for a different trigger message with an identical session or procedure number after number wrap around.

5. The apparatus of claim 2, wherein the processor configures the A-IoT device to start a timer in response to triggering of the random access procedure or restart the timer in response to triggering a new random access procedure.

6. The apparatus of claim 5, wherein the trigger message indicates that the random access procedure is to be triggered in response to the timer having expired.

7. The apparatus of claim 2, wherein:
the processor configures the A-IoT device to determine allowed transmission timing based on messages transmitted by the reader, and
the transmission timing is a period at least one of:
between two consecutive reader-to-device (R2D) messages, or
within a minimum response time and a maximum response time after reception of a first R2D message.

8. The apparatus of claim 1 wherein the condition is indicated in the trigger message.

9. The apparatus of claim 1 wherein the condition is a number of A-IoT devices for which the trigger message is intended.

10. The apparatus of claim 9 wherein the processor configures the A-IoT device to:
determine whether the trigger message is a broadcast message, and
in response to a determination that the trigger message is the broadcast message, use the random access procedure to transmit the D2R message.

11. The apparatus of claim 1 wherein:
the processor configures the A-IoT device to determine an amount of energy available, and
the condition is dependent on whether the amount of energy available is sufficient to respond to the trigger message.

12. The apparatus of claim 1 wherein the processor configures the A-IoT device to:
determine whether a random access-related failure has occurred, and
respond to the trigger message in a next transmission timing in response to a determination that the condition has been met and the random access-related failure has occurred.

13. The apparatus of claim 12 wherein the random access-related failure comprises at least one of a contention resolution failure or an absence of feedback from the reader.

14. The apparatus of claim 1, wherein:
the D2R message comprises a contention resolution ID, and
the processor configures the A-IoT device to:
receive, from the reader, an acknowledgement message that contains a response contention resolution ID,
determine whether the contention resolution ID and the response contention resolution ID are identical, and
determine that contention resolution is successful in response to a determination that the contention resolution ID and the response contention resolution ID are identical.

15. The apparatus of claim 1, wherein the processor configures the A-IoT device to determine whether to use the random access procedure based on a value of an indication bit in the trigger message.

16. The apparatus of claim 1, wherein the processor configures the A-IoT device to determine whether to use the random access procedure based on absence of an indication bit in the trigger message.

17. An apparatus of a reader, the apparatus comprising a memory configured to store parameters for a random access procedure and a processor, the processor to configure the reader to:
send, to an Ambient Internet of Things (A-IoT) device, a trigger message indicating whether the A-IoT device is to perform the random access procedure based on at least one of a session or procedure number, an indication bit, or timing parameters; and
receive, from the A-IoT device in response to the trigger message, a device-to-reader (D2R) message using the random access procedure.

18. The apparatus of claim 17, wherein the random access procedure is based on a value of the indication bit in the trigger message.

19. A non-transitory computer-readable storage medium that stores instructions for execution by one or more processors of an apparatus of an Ambient Internet of Things (A-IoT) device, the instructions, when executed, cause the A-IoT device to:
receive a trigger message from a reader, the trigger message indicating whether the A-IoT device is to perform a random access procedure;
determine, based on the trigger message, whether a condition to trigger the random access procedure is met;
determine whether to respond to the trigger message; and
in response to a determination that the A-IoT device is to respond to the trigger message and that the condition to trigger random access is met, transmit a device-to-reader (D2R) message to the reader using the random access procedure.

20. The non-transitory computer-readable storage medium of claim 19, wherein the trigger message includes the condition, and the condition comprises at least one of a session or procedure number, an indication bit to trigger the random access procedure, or timing parameters.
